(19) United States
(12) Patent Application Publication
(10) Pub. No.: US 2016/0055949 A1
(43) Pub. Date: Feb. 25, 2016

(54) CRYOSTAT

(71) Applicant: JAPAN SUPERCONDUCTOR TECHNOLOGY, INC., Hyogo (JP)

(72) Inventors: Kazuhito TAGO, Kobe-shi (JP); Akihiro OTSUKA, Kobe-shi (JP)

(73) Assignee: JAPAN SUPERCONDUCTOR TECHNOLOGY INC., Hyogo (JP)

(21) Appl. No.: 14/780,351

(22) PCT Filed: Mar. 7, 2014
(86) PCT No.: PCT/JP2014/055966

§ 371 Date: Sep. 25, 2015

(30) Foreign Application Priority Data
Mar. 27, 2013 (JP) 2013-066832

(51) Int. Cl. H01F 6/04; F25D 3/10; F17C 3/08

(52) U.S. Cl. CPC H01F 6/04; F17C 3/085; F25D 3/107; F17C 2221/017; F17C 2270/0509

(57) ABSTRACT

The purpose of the present invention is to reduce vibration derived from a refrigeration machine. A cryostat comprises: a helium tank (2) which stores liquid helium; a refrigeration machine (5) which is provided above the helium tank (2) and re-liquefies the vaporized liquid helium in the helium tank (2); a cylindrical member (15) which houses the lower part of the refrigeration machine (5) and forms a liquefaction chamber (8) communicating with the helium tank (2); and a buffer tank (10) which stores helium gas and communicates with at least either the space above the surface of the liquid helium in the helium tank (2) or the liquefaction chamber (8). The gas-phase volumes of the helium tank (2) and the liquefaction chamber (8) increase by having the buffer tank (10) communicate with the helium tank (2) and the liquefaction chamber (8).

### TECHNICAL FIELD

The present invention relates to a cryostat for cooling a superconducting magnet and the like.

### BACKGROUND ART

In a superconducting magnet device applied to an NMR apparatus or the like, in order to zero the consumption of liquid helium which serves as a refrigerant, a refrigeration machine for re-condensing the evaporated refrigerant is used. However, since the magnetic field disturbance generated by the vibration generated by the refrigeration machine occurs, a problem of noise mixed in NMR signals obtained by NMR apparatus arises.

Accordingly, Patent Literature 1 describes a cryostat assembly having a plug disposed in a communication passage between a liquefaction chamber that houses the lower portion of a refrigeration machine and a refrigerant tank that stores liquid helium. The plug has a plurality of holes each having a diameter that is sufficiently smaller than the wavelength of an acoustic wave generated by the refrigeration machine. Helium gas generated when the liquid helium evaporates in the refrigerant tank enters the liquefaction chamber through the plurality of holes. Liquid helium generated by re-liquefying the helium gas is returned to the refrigerant tank through the plurality of holes. At that time, the acoustic wave generated by the refrigeration machine is attenuated when passing through the plurality of holes.

### CITATION LIST

### Patent Literature

PTL 1: Japanese Unexamined Patent Application Publication No. 2006-184280

### SUMMARY OF INVENTION

### Technical Problem

However, the plug described in Patent Literature 1 has the following problem. That is, when the refrigeration machine is subjected to a maintenance operation, the refrigerant tank is temporarily opened. At that time, slight air may enter the refrigerant tank. The air left in the refrigerant tank is cooled by the refrigerant and is condensed and, thus, remains in the refrigerant tank. If the condensed air clogs the plurality of holes in the plug, the communication passage between the refrigerant tank and the liquefaction chamber is closed and, thus, fatal failure occurs in the re-condensing function.

An object of the present invention is to provide a cryostat capable of reducing vibration transferred from the refrigeration machine.

### Solution to Problem

The present invention provides a cryostat including a refrigerant tank that stores liquid refrigerant, a refrigeration machine disposed above the refrigerant tank, where the refrigeration machine reliquefies the refrigerant evaporated inside the refrigerant tank, a cylindrical member that forms a liquefaction chamber housing a lower portion of the refrigeration machine and communicating with the refrigerant tank, and storage means for communicating with at least one of a space inside the refrigerant tank above the liquid level of the liquid refrigerant and the liquefaction chamber and storing gaseous refrigerant.

### Advantageous Effects of Invention

According to the present invention, by allowing the storage means that stores gaseous refrigerant to communicate with at least one of a space inside the refrigerant tank above the liquid level of the liquid refrigerant and the liquefaction chamber, the gas phase capacity of the refrigerant tank and the liquefaction chamber can be increased. At that time, the acoustic vibration (the pressure fluctuation) transferred from the refrigeration machine is caused by the liquefaction cycle of the refrigeration machine. The pressure fluctuation tends to be reduced with increasing gas phase capacity against the amount of liquefaction per unit time. Accordingly, by increasing the sizes of the refrigerant tank and the liquefaction chamber, the gas phase capacity can be increased. However, if the sizes of the refrigerant tank and the liquefaction chamber are increased, the size of the cryostat is increased. Thus, a larger installation area is needed. In addition, since the surface area of the cryostat increases, an amount of entering heat increases and, thus, the load imposed on the refrigeration machine increases. As a result, by connecting the storage means that stores the gaseous refrigerant to the refrigerant tank or the liquefaction chamber to increase the gas phase capacity using the storage means, the pressure fluctuation caused by the refrigeration machine is reduced. In this manner, the pressure fluctuation caused by the refrigeration machine can be reduced.

### BRIEF DESCRIPTION OF DRAWINGS

FIG. 1 is a side view illustrating the internal structure of a cryostat.

FIG. 2 illustrates the calculated values and the measured values of pressure fluctuation.

FIG. 3 illustrates the result of measurement of a time variation of the pressure fluctuation.

FIG. 4A illustrates an NMR signal.

FIG. 4B illustrates an NMR signal.

### DESCRIPTION OF EMBODIMENTS

An exemplary embodiment of the present invention is described below with reference to the accompanying drawings.

### (Structure of Cryostat)

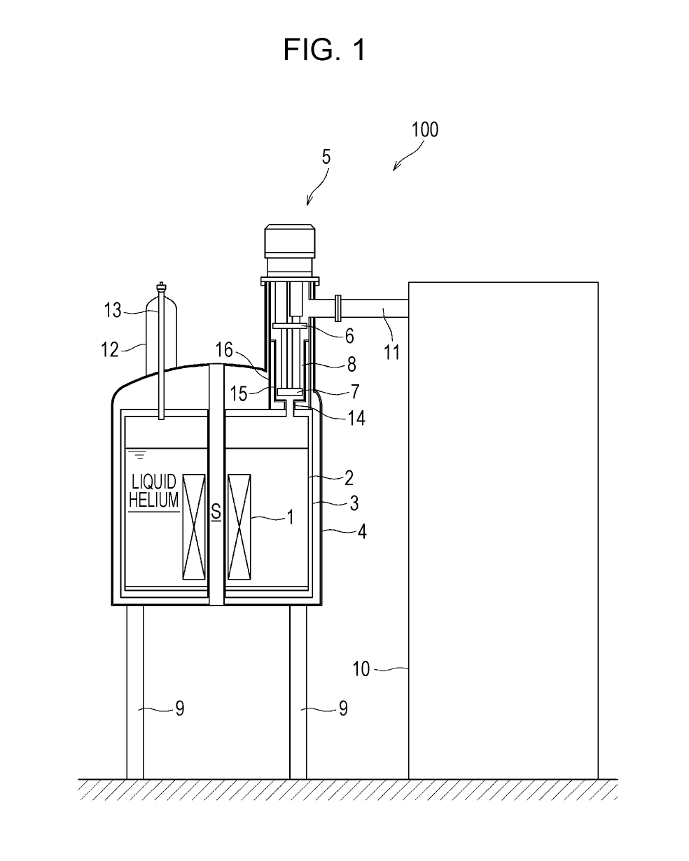

As illustrated in FIG. 1, a cryostat 100 according to a first embodiment of the present invention includes a helium tank (a refrigerant tank) 2 that stores liquid helium serving as liquid refrigerant, a refrigeration machine 5 disposed above the helium tank 2, a cylindrical member 15 that forms a liquefaction chamber 8 communicating with the helium tank 2, and a buffer tank (storage means) 10 that communicates with the liquefaction chamber 8. Note that while the cryostat 100 according to the present embodiment is used for NMR apparatuses, usage of the cryostat 100 is not limited thereto. For example, the cryostat 100 may be used for MRI apparatuses. In addition, the refrigerant is not limited to helium.

The helium tank 2 has a gas outlet port (not illustrated). The gas outlet port serves as a pathway used when the refrigeration machine 5 loses its refrigerating capability and, thus, helium gas evaporates. The gas outlet port is disposed in a top end portion of a tubular member 13 described below. The gas outlet port has a check valve in the upper section thereof. The check valve prevents air from entering the helium tank 2 from the outside. Accordingly, even when the helium gas in the helium tank 2 is cooled by the refrigeration machine 5 and, thus, is liquefied, the total amount of helium in the helium tank 2 remains unchanged. In addition, to prevent air from entering the helium tank 2, the pressure inside the helium tank 2 is controlled so as to be a positive pressure that is slightly higher than the atmospheric pressure. Examples of the material of the helium tank 2 includes aluminum and stainless steel.

The helium tank 2 has a superconducting magnet 1 disposed therein. The superconducting magnet 1 is formed by spirally winding a superconducting wire around a winding frame (not illustrated). The superconducting wire may be a metal-based superconducting wire or an oxide-based superconducting wire. In addition, the helium tank 2 has a cylindrical space S (a bore) formed at the center thereof so that the cylindrical space S extends in the vertical direction. A specimen is placed in the cylindrical space S, and a variety of analysis and experiments are conducted.

The helium tank 2 is enclosed by a radiation shield 3. The radiation shield 3 is in the form of a shielding container that is cooled by the cold energy of the helium gas in order to prevent the cold energy of the helium tank 2 from dissipating more. In addition, the radiation shield 3 is forcibly cooled by a first cooling stage 6 (described below) of the refrigeration machine 5. Examples of the material of the radiation shield 3 include aluminum and copper.

In addition, the helium tank 2 and the radiation shield 3 are disposed inside a vacuum case 4. A high vacuum is maintained inside the vacuum case 4. Thus, the vacuum case 4 prevents heat from entering the superconducting magnet 1 and the helium tank 2. The vacuum case 4 has a neck member 12 in the upper portion thereof. The neck member 12 has the tubular member 13 therein. The tubular member 13 is used as, for example, a passage that allows a current lead (not illustrated) to be inserted thereinto and a passage that is used to fill up the helium tank 2 with liquid helium. In addition, the vacuum case 4 is supported by a plurality of stands 9 on the floor. Examples of the material of the vacuum case 4 include aluminum and stainless steel.

The refrigeration machine 5 is provided to reliquefy the liquid helium that is evaporated inside the helium tank 2. According to the present embodiment, a pulse tube refrigeration machine is used as the refrigeration machine 5. The refrigeration machine 5 has the first cooling stage 6 (a 1nd stage) in the middle portion thereof in the vertical direction. In addition, the refrigeration machine 5 has a second cooling stage 7 (a 2nd stage) in the lower end portion thereof. Each of the first cooling stage 6 and the second cooling stage 7 has a shape of a flange. The first cooling stage 6 and the second cooling stage 7 are cooled by the refrigeration machine 5 so as to have temperatures of, for example, about 40 K and about 4 K, respectively. The material of the first cooling stage 6 and the second cooling stage 7 is mainly copper or a copper alloy. Note that the refrigeration machine 5 is not limited to a pulse tube refrigeration machine. For example, the refrigeration machine 5 may be a GM refrigeration machine or a starling refrigeration machine.

The cylindrical member 15 contains the lower portion of the refrigeration machine 5 including the second cooling stage 7. In addition, a cylindrical member 16 is further disposed outside the cylindrical member 15. The inner space of the cylindrical member 15 serves as the liquefaction chamber 8. The liquefaction chamber 8 communicates with the helium tank 2 via a cylindrical communication member 14 having a diameter that is smaller than the diameter of the cylindrical member 15.

The buffer tank 10 has a larger gas phase capacity than the helium tank 2 and the liquefaction chamber 8. The buffer tank 10 stores helium gas serving as gas refrigerant. According to the present embodiment, the gas phase capacity of the liquefaction chamber 8 is 3.5 L. In contrast, the gas phase capacity of the buffer tank 10 is 250 L. The buffer tank 10 is disposed on the floor. By allowing the buffer tank 10 having such a structure to communicate with the liquefaction chamber 8 via a communication passage 11, the gas phase capacity of the liquefaction chamber 8 is increased. Examples of the material of the buffer tank 10 include aluminum and stainless steel.

In this case, the acoustic vibration (the pressure fluctuation) transferred from the refrigeration machine 5 is caused by a liquefaction cycle of the refrigeration machine 5. Note that the pressure fluctuation tends to reduce with increasing gas phase capacity against the amount of liquefied helium per unit time. Accordingly, by increasing the sizes of the helium tank 2 and the liquefaction chamber 8, the gas phase capacity can be increased. However, if the sizes of the helium tank 2 and the liquefaction chamber 8 are increased, the size of the cryostat 100 increases. Thus, a larger installation area is needed. In addition, since the surface area of the cryostat 100 increases, an amount of entering heat increases and, thus, the load imposed on the refrigeration machine 5 increases.

Thus, according to the present embodiment, the buffer tank 10 is connected to the liquefaction chamber 8 to increase the gas phase capacity of the liquefaction chamber 8 using the buffer tank 10. In this manner, the pressure fluctuation caused by the refrigeration machine 5 is reduced.

Alternatively, by allowing the buffer tank 10 to communicate with the space inside the helium tank 2 above the liquid level of the liquid helium and, thus, increasing the gas phase capacity of the helium tank 2, the pressure fluctuation caused by the refrigeration machine 5 can be reduced. However, since the capacity of the liquefaction chamber 8 is smaller than that of the helium tank 2, the pressure fluctuation is more easily transferred in the liquefaction chamber 8 than in the helium tank 2. To prevent the pressure fluctuation from easily transferring, it is more effective to increase the gas phase capacity on the liquefaction chamber-8 side than to increase the gas phase capacity on the helium tank-2 side.

### (Evaluation of Pressure Fluctuation)

Subsequently, the values of the pressure fluctuation caused by the refrigeration machine 5 when the gas phase capacity on the liquefaction chamber-8 side was changed were evaluated. The calculated values of the pressure fluctuation were obtained using a calculation model. The result of the calculation is shown in Table 1.

TABLE 1

| Liquefaction Chamber Side | Pressure Fluctuation (Pa) |
|---|---|
| Gas Phase Capacity (L) | (Calculated Value) |
| 4 | 11.00 |
| 10 | 9.00 |
| 20 | 7.00 |
| 30 | 5.75 |
| 40 | 5.00 |
| 50 | 4.25 |
| 70 | 3.43 |
| 100 | 2.60 |
| 150 | 1.88 |
| 200 | 1.45 |
| 250 | 1.20 |
| 300 | 1.00 |
| 350 | 0.88 |
| 400 | 0.78 |
| 450 | 0.70 |
| 500 | 0.63 |

Subsequently, the measured values were obtained by actually changing the gas phase capacity on the liquefaction chamber-8 side. The result of the measurement is shown in Table 2.

TABLE 2

| Liquefaction Chamber Side | Pressure Fluctuation (Pa) |
|---|---|
| Gas Phase Capacity (L) | (Measured Value) |
| 3.5 | 8 |
| 50 | 4 |
| 250 | 1.3 |

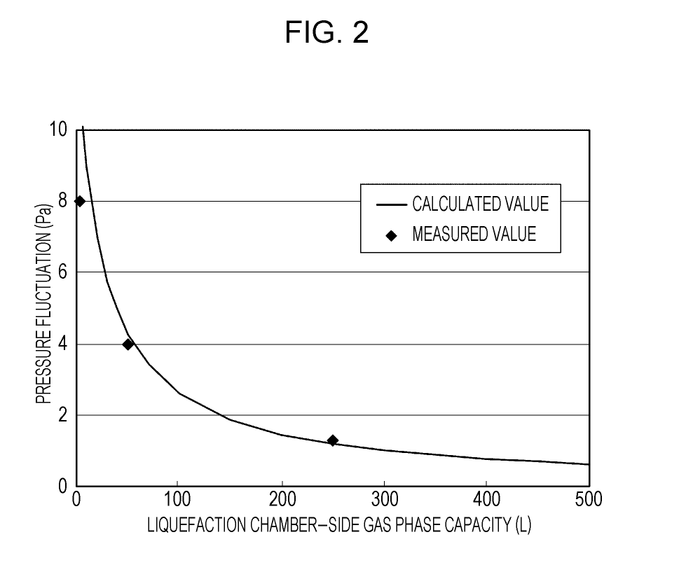

The calculated values and the measured values of the pressure fluctuation are illustrated in FIG. 2. As can be seen from FIG. 2, the pressure fluctuation tends to be reduced with increasing gas phase capacity on the liquefaction chamber-8 side.

### (Time Variation of Pressure Fluctuation)

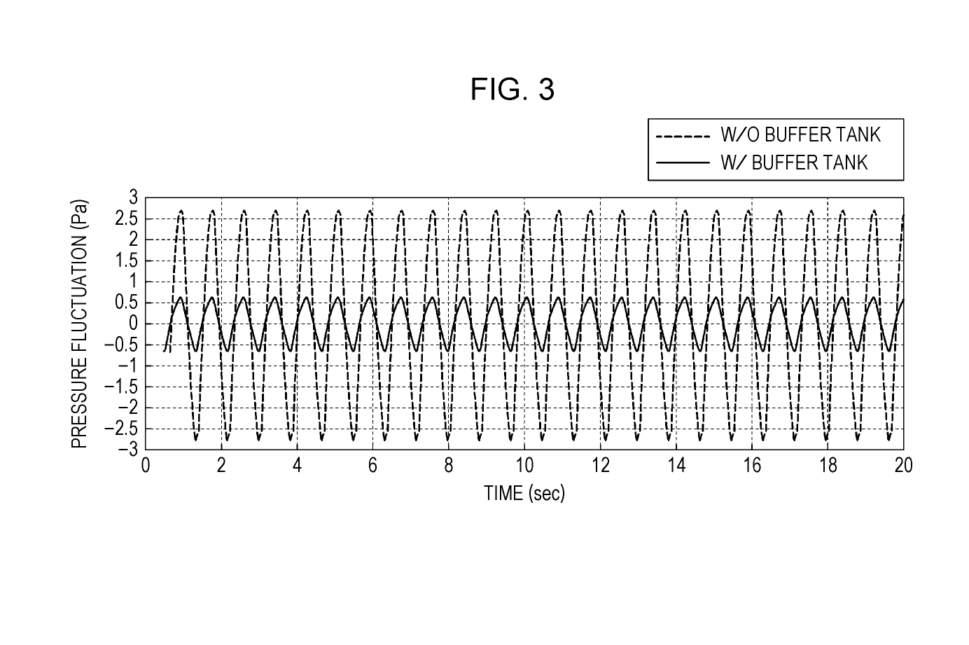

Subsequently, the time variation of the pressure fluctuation occurring in the helium tank 2 when the buffer tank 10 is connected to the liquefaction chamber 8 and the time variation occurring when the buffer tank 10 is not connected to the liquefaction chamber 8 were measured. The measuring conditions are as follows:
the capacity (the gas phase capacity) of the buffer tank 10 was set to 250L,
the liquid level of the liquid helium in the helium tank 2 was set to 69% of the overall height of the inside of the helium tank 2, and
the base pressure of the helium tank 2 was set to 2.3 kPa.
   The result of the measurement is illustrated in FIG. 3.

The peak-to-peak value of the pressure fluctuation obtained when the buffer tank 10 is not connected to the liquefaction chamber 8 is about 6 Pa. In contrast, the peak-to-peak value of the pressure fluctuation obtained when the buffer tank 10 is connected to the liquefaction chamber 8 is about 1.3 Pa. As can be seen from the result, by increasing the gas phase capacity of the liquefaction chamber 8 using the buffer tank 10, the pressure fluctuation can be reduced.

### (Evaluation of Noise of NMR Signal)

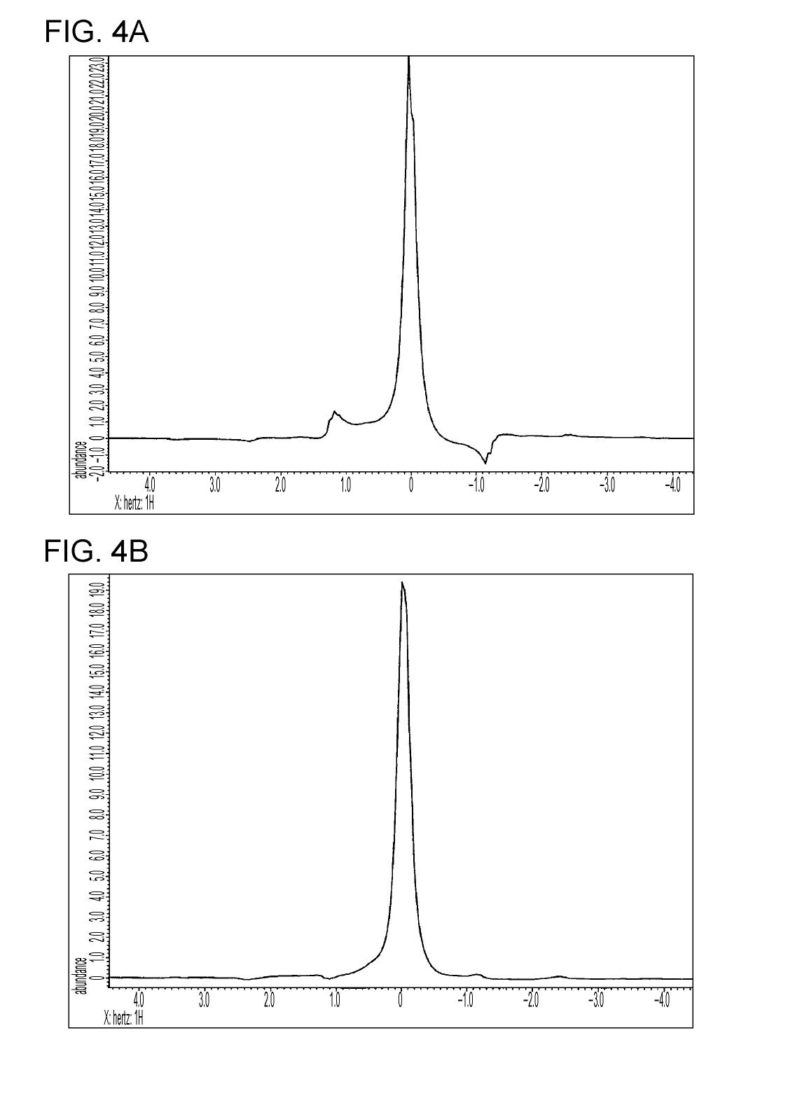

Subsequently, noise appearing in the NMR signal when the buffer tank 10 is connected to the liquefaction chamber 8 and noise when the buffer tank 10 is not connected to the liquefaction chamber 8 are evaluated. The result of the evaluation is illustrated in FIGS. 4A and 4B.

As illustrated in FIG. 4A, when the buffer tank 10 is not connected to the liquefaction chamber 8, significant noise appears in the NMR signal. In contrast, as illustrated in FIG. 4B, when the buffer tank 10 is connected to the liquefaction chamber 8, the noise appearing in the NMR signal is reduced. As can be seen from the result, by increasing the gas phase capacity of the liquefaction chamber 8 using the buffer tank 10 and, thus, reducing the vibration caused by the refrigeration machine 5, the noise appearing in the NMR signal can be reduced.

### (Effects)

As described above, according to the cryostat 100 of the present embodiment, by allowing the buffer tank 10 that stores helium gas to communicate with at least one of a space inside the helium tank 2 above the liquid level of the liquid helium and the liquefaction chamber 8, the gas phase capacity of the helium tank 2 and the liquefaction chamber 8 can be increased. At that time, the acoustic vibration (the pressure fluctuation) transferred from the refrigeration machine 5 is caused by the liquefaction cycle of the refrigeration machine 5. The pressure fluctuation tends to be reduced with increasing gas phase capacity against the amount of liquefaction per unit time. Accordingly, by increasing the sizes of the helium tank 2 and the liquefaction chamber 8, the gas phase capacity can be increased. However, if the sizes of the helium tank 2 and the liquefaction chamber 8 are increased, the size of the cryostat 100 is increased. Thus, a larger installation area is needed. In addition, since the surface area of the cryostat 100 increases, an amount of entering heat increases and, thus, the load imposed on the refrigeration machine 5 increases. As a result, by connecting the buffer tank 10 to the helium tank 2 or the liquefaction chamber 8 to increase the gas phase capacity using the buffer tank 10, the pressure fluctuation caused by the refrigeration machine 5 is reduced. In this manner, the vibration caused by the refrigeration machine 5 can be reduced.

In addition, the buffer tank 10 is allowed to communicate with the liquefaction chamber 8. Since the gas phase capacity of the liquefaction chamber 8 is smaller than that of the helium tank 2, the pressure fluctuation is more easily transferred in the liquefaction chamber 8 than in the helium tank 2. Accordingly, to prevent transfer of the pressure fluctuation, it is more effective to increase the gas phase capacity on the liquefaction chamber-8 side than to increase the gas phase capacity on the helium tank-2 side. Thus, by allowing the buffer tank 10 to communicate with the liquefaction chamber 8, the gas phase capacity on the liquefaction chamber-8 side is increased. In this manner, the pressure fluctuation caused by the refrigeration machine 5 can be appropriately reduced.

In addition, by reducing the vibration generated by the refrigeration machine 5 when the superconducting magnet 1 is disposed inside the helium tank 2 and is used for high-resolution NMR, noise appearing in the NMR signal can be reduced. In this manner, noise appearing in an NMR signal can be reduced.

It should be noted that while the embodiment of the present invention have been described, the present invention is not limited by the above-described embodiment. The design of the particular structures can be modified as needed. In addition, the operations and effects described in the embodiments of the present invention are only exemplary operations and effects attainable by the present invention. The operations and effects of the present invention are not limited to those described in the embodiment of the present invention.

For example, while the present embodiment has been described with reference to the buffer tank 10 serving as the storage means that stores helium gas, the storage means is not limited to a container. The storage means may be a bag or an airtight chamber.

In addition, while the present embodiment has been described with reference to the buffer tank 10 communicating with the liquefaction chamber 8, the buffer tank 10 may be communicated with both the helium tank 2 and the liquefaction chamber 8.

### REFERENCE SIGNS LIST

1 superconducting magnet

2 helium tank (refrigerant tank)

3 radiation shield

4 vacuum case

5 refrigeration machine

5 first cooling stage

7 second cooling stage

8 liquefaction chamber

9 stand

10 buffer tank (storage means)

11 communication passage

12 neck member

13 tubular member

14 communication member

15 cylindrical member

16 cylindrical member

100 cryostat

1. A cryostat comprising:
a refrigerant tank that stores liquid refrigerant;
a refrigeration machine disposed above the refrigerant tank, the refrigeration machine reliquefying the refrigerant evaporated inside the refrigerant tank;
a cylindrical member that forms a liquefaction chamber housing a lower portion of the refrigeration machine and communicating with the refrigerant tank; and
storage means for communicating with at least one of a space inside the refrigerant tank above the liquid level of the liquid refrigerant and the liquefaction chamber and storing gaseous refrigerant.

2. The cryostat according to claim 1, wherein the storage means communicates with the liquefaction chamber.

3. The cryostat according to claim 1, wherein a superconducting magnet is disposed inside the refrigerant tank.

4. The cryostat according to claim 2, wherein a superconducting magnet is disposed inside the refrigerant tank.
